(19) United States
(12) Patent Application Publication
(10) Pub. No.: US 2006/0142878 A1
(43) Pub. Date: Jun. 29, 2006

(54) System for virtual process interfacing via a remote desktop protocol (rdp)

(75) Inventors: Thomas Banik, Erlangen (DE); Hendrik Gerlach, Erlangen (DE); Stefan List, Furth (DE); Thomas Talanis, Heroldsbach (DE); Thomas Troster, Dittenheim (DE); Frank Volkmann, Nurnberg (DE)

Correspondence Address: Siemens Corporation;Intellectual Property Department, 170 Wood Avenue South, Iselin, NJ, 08830, US

(73) Assignee: Siemens Aktiengesellschaft, Muenchen (DE)

(21) Appl. No.: 10/527,913

(22) PCT Filed: Sep. 1, 2003
(86) PCT No.: PCT/DE03/02888

§ 371 Date: Mar. 16, 2005

(30) Foreign Application Priority Data
Sep. 16, 2002 (DE) 102 42 919.7

(51) Int. Cl. G05B 11/01; G05B 19/18

(52) U.S. Cl. 700/17; 700/19; 700/83; 700/65

(57) ABSTRACT

The invention relates to a system and a method for virtual on line process interfacing for distributed engineering systems in automation technology based on a remote desktop protocol. A communication channel is established from any client within the system to a server via the RDP by means of online access. Process data and project planning data are tunneled via the channel. Quasi peer-to-peer communication between random clients in the system is made possible by means of routing on the server.

### CROSS REFERENCE TO RELATED APPLICATIONS

This application is the US National Stage of International Application No. PCT/DE2003/002888, filed Sep. 1, 2003 and claims the benefit thereof. The International Application claims the benefits of German application No. 10242919.7 filed Sep. 16, 2002, both applications are incorporated by reference herein in their entirety.

### FIELD OF THE INVENTION

The invention relates to a system and a method for process interfacing within an automation scenario for distributed engineering systems using a Remote Desktop Protocol (RDP).

### BACKGROUND OF THE INVENTION

Present-day engineering systems employed in the field of automation technology are as a rule what are termed monolithic systems offering no options for distributed engineering or distributed project planning. Owing to the increasing complexity and physical extent of installations and automation systems it is, however, desirable to be able to access process data, diagnostic data, and project-planning data required for engineering purposes from any location within the installation or automation system. What are termed terminal server solutions based on transporting image data (bitmaps) from the server to the client are presently employed for this purpose, with keyboard and mouse actions being conveyed from the client to the server. It is not, however, possible to access simply any online data via a central engineering system, which is to say data stored on the relevant CPU of a client present in the periphery such as, for example, an operator panel or a programming device. Nor is project-planning data stored on a client of said type directly available to the engineering system.

### SUMMARY OF THE INVENTION

The object of the invention is to disclose a system and a method enabling process interfacing within an automation scenario for accessing process data and project-planning data for engineering.

Said object is achieved by means of a system for process interfacing within an automation scenario for distributed engineering systems having a server for provisioning at least one application required for engineering, at least one client for accessing automation devices that supply process data and/or project-planning data, and for setting up an online communication channel maintained for any length of time between the client and server, first means for feeding data of the automation devices into the server over the communication channel, and second means for linking the applications to the automation devices, with the first means having a first interface to the current communication channel and a second interface to the applications and being provided for communicating with the second means over the communication channel.

The invention is based on the knowledge that the engineering systems currently employed for engineering within an automation scenario are as a rule monolithic, which is to say are installed on a central server and can only be operated there. In modern installations, characterized by increasing complexity, heterogeneity, and decentralization, it is however advantageous if the engineering systems can be operated from different locations or sites and if any process data or project-planning data can be accessed from said locations. In the proposed invention, virtual process interfacing effected via an online communication channel is for this purpose set up from the engineering system on a server to any automation devices that are addressable via clients. The proposed system thus enables an engineering system to be operated from any location within the system, including the accessing of process data and diagnostic data. The optimized deployment of resources on the installation within the automation system is herein especially advantageous. The clients employed can be, for example, thin clients, since no applications have to run thereon themselves. The applications are instead installed on the server; they can, however, be used remotely online via the client, and the required data is also available via the communication channel. Engineering can thereby be performed significantly more variably and flexibly. Virtual process interfacing via the online data channel also makes distributed engineering possible in monolithic systems. Users only require an online access for data accessing and engineering. The system can also be operated from the client. The engineering system does not have to be located on the computer used by the application. Online access to the automation devices is provided by the communication channel by means of what is termed tunneling of communication data packets.

A further advantageous embodiment of the invention is characterized in that the client is embodied as a programming device and/or as an operator panel and/or as a diagnostic device and/or as a browser and/or as a Windows CE device. It is especially advantageous herein that any devices present on the installation that are generally already employed at present for observing and operating the installation or automation system can in the proposed system according to the invention also be used for operation. The relevant control data or diagnostic data, for instance, of the automation devices can be conveyed to the server over the communication system via a conventional programming device or via an operator panel and will thus be available to the engineering system on the server. Engineering itself can in turn be performed directly from the proposed clients.

A further advantageous embodiment of the invention is characterized in that the server is embodied as a terminal server for use simultaneously by one or more participants. The server or proposed system therefore has multi-user capability, and engineering tasks requiring access to process data or diagnostic data can be performed within the system by several users simultaneously.

A further advantageous embodiment of the invention is characterized in that the communication channel is embodied as a Remote Desktop Protocol for transmitting data to one or more participants in realtime over one or more separate virtual channels. Using Microsoft's Remote Desktop Protocol (RDP) enables data packets to be sent efficiently and rapidly over the communication channel between a client and the server, thus substantially improving engineering and the accessing of the process data or project-planning data. Several data packets can moreover be sent over the communication channel by several users of the system simultaneously and mutually independently without the occurrence of negatively impacting interactions. The possibility of using several separate virtual channels for transferring data furthermore renders the system variable, flexible, and freely scalable. Any number of users (limited only by the server's capacities) can work simultaneously within the system on different clients.

A further advantageous embodiment of the invention is characterized in that the first means are provided for feeding data of further automation devices into the server over the communication channel via at least one further client. Said embodiment of the invention enables the accessing from any client of automation devices connected to any other client within the system and of said automation devices' relevant data. Routing is for this purpose undertaken on the server so that virtual peer-2-peer communication (direct communication) between the participating clients is rendered possible. Possibilities are thereby realized for accessing and configuring from one client system to another client system. Any process data or diagnostic data stored or arising at another location within the system is hence available at any location within the system.

A further advantageous embodiment of the invention is characterized in providing for the transmission of data in the communication channel over an intranet and/or the internet. There is thus no need to establish separate infrastructures for the proposed system such as special networks. An intranet or, as the case may be, the internet provided as standard can be used and the standard protocols employed therefor will be available for communication also. This will allow the system according to the invention to be implemented economically with no further expenditure requirements.

A further advantageous embodiment of the invention is characterized in providing for the transmission of data from the client using a Remote Desktop Protocol over a Wireless LAN (W-LAN). The clients used within the system such as, for instance, programming devices, operator panels, diagnostic devices, and browsers of whatever kind do not require a cable connection directly. Rather it is the case that the data can be transmitted cordlessly over a W-LAN network. Using networks of this kind has the advantage that users do not have to remain statically at one location but instead only need to stay, together with their client, within a specific area or periphery within which they are able to transmit data by means of a W-LAN. Employing a W-LAN thus permits greater user mobility on the installation.

A further advantageous embodiment of the invention is characterized in providing for the transmission of data using a Remote Desktop Protocol from further data sources present in the system employing further standard protocols such as HTTP and/or FTP. Data reaching the system by way of other communication methods and networks can thus be sent within the system over the same communication channels. It is thus available to any user in the same way as the data of the automation devices connected to the clients. Universal access to all relevant data for the installation or for the automation system is thereby ensured.

A further advantageous embodiment of the invention is characterized in that the system provides for use across different sites. Distributed engineering by means of virtual access to process data and project-planning data is hence possible not only at one site within an installation; rather it is the case that cross-site access to all relevant data is also facilitated. The proposed system is hence eminently suitable for the engineering of decentralized automation systems. It is especially advantageous herein that the clients employed can be simple and need to have few resources. The applications are made available directly by the server. Remote maintenance or, as the case may be, remote diagnosis is furthermore also facilitated by the possibility of accessing project-planning and process data on a cross-site basis. Experts, who may not be directly present on site, are able to access the relevant data from any location via the distributed system.

The invention is described and explained in more detail below with the aid of the exemplary embodiments shown in the figures.

### BRIEF DESCRIPTION OF THE DRAWINGS

FIG. 1 is a schematic of the system for virtual online process interfacing within an automation scenario,

FIG. 2 is a schematic of the possibilities for accessing and configuring between two clients within the system, and

FIG. 3 is a schematic of communication within the system across different sites by means of an intranet/the internet.

### DETAILED DESCRIPTION OF THE INVENTION

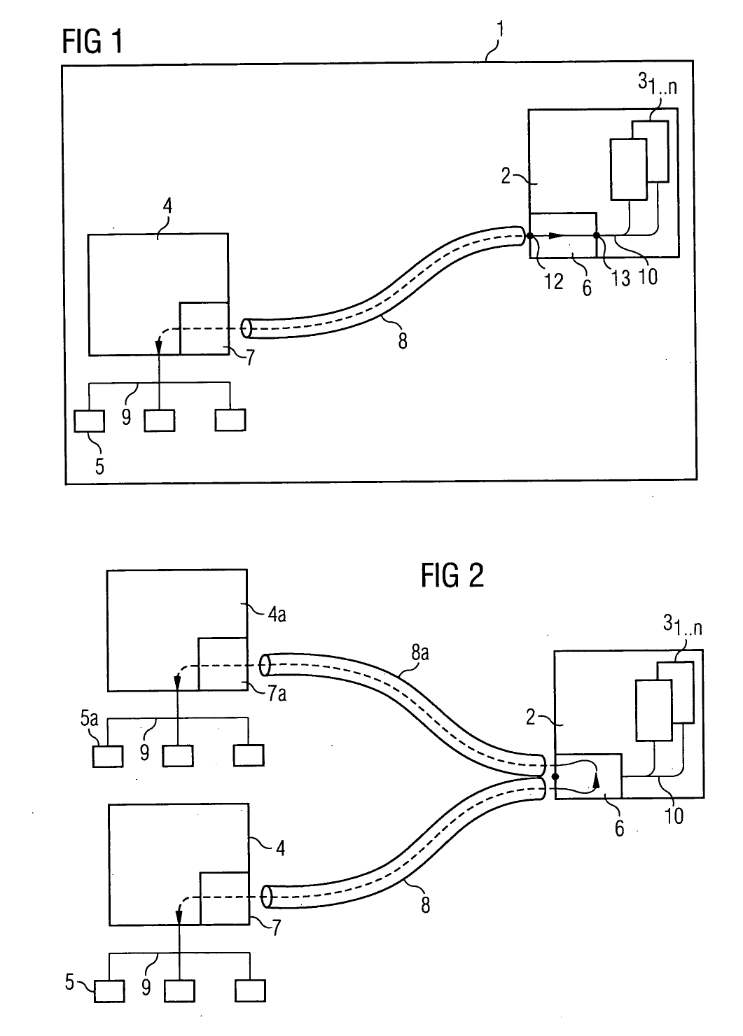

FIG. 1 is a schematic of an exemplary embodiment of the system 1 for virtual process interfacing within an automation scenario for distributed engineering in monolithic systems. Applications 3_{1 . . . n} required for engineering are herein stored and made available on a central server 2 within the system 1. Automation devices 5 present within the automation scenario are connected via a data transmission device 9, for example a bus system, to a client 4. The data of the automation devices 5 can be accessed directly from the client. Communication between the terminal server 2 and the client 4 for online process interfacing is realized with the aid of the communication channel 8. What is termed a Remote Desktop Protocol is employed herein that enables data packets to be transmitted online over virtual channels. Accessing of the online data of the automation devices by the terminal server 2 is enabled by means of the data channel 8. Means 6 for feeding in data of the automation devices 5 over the communication channel 8 are located for this purpose on the terminal server. Said means are as a rule software which runs on the terminal server 2 and ensures that the server 2 is automatically redirected to the automation device 5 of the corresponding client 4. Said software has two interfaces for communicating, firstly, with the communication channel 8 and, secondly, with the applications 3_{1 . . . n}. Second means 7 on the client 4 link said applications 3_{1 . . . n} to the respective automation devices 5.

The special feature of the system 1 shown by way of example in FIG. 1 is that process data and diagnostic data from automation devices 5 can be made available at any time on a terminal server 2 in realtime by means of a data transmission channel 8. An online data connection is set up for this purpose by the client 4 using what is termed a Remote Desktop Protocol. The means 7 for linking the applications 3_{1 . . . n} from the server 2 to the automation devices 5 are herein realized as a software component in the form of what is termed an online RDP proxy. Said online RDP proxy links the engineering system to the respective automation devices 5. Further means 6 for feeding in data of the automation devices 5 over the communication channel 8 are realized on the server 2. Said means are realized in the form of software, namely what is termed an online RDP DLL. Said online RDP DLL locates the corresponding online RDP proxy and the data of the automation devices 5 is then transmitted over the communication channel 8. Transmitting by means of the Remote Desktop Protocol entails the use of a standard protocol enabling the data of an application to be transmitted over several virtual channels to several users in realtime. The data is herein transmitted individually for each “session” (which is to say the respective user's duration of working). The data is herein transmitted, employing the protocol, in what are termed data packets, which are individually encrypted and packed then dispatched with a recipient's address. The specificity of dispatching employing the Remote Desktop Protocol is that what is termed tunneling takes place. The users or, as the case may be, the server 2 and the client 4 are not involved in the actual data-dispatching process; rather it is the case that data transformation takes place within the scope of the RDP protocol. An online connection to the server must exclusively be set up by the client. The online RDP DLL on the server 2 and the online RDP proxy on the client 4 are responsible exclusively for provisioning the data and for determining the correct address to which said data is to be dispatched. The principal advantage of transmitting data in said manner employing an online RDP standard protocol is that an existing infrastructure such as, for instance, the internet, can be used for data transmission. The laying of cables or installation of other data transmission devices within the system 1 is rendered superfluous, meaning that the transmission of data can be realized economically. Process data or diagnostic data can also be transmitted in realtime. Specific applications 3_{1 . . . n} made available on a server 2 can furthermore be used by any clients 4 within the system 1. A user can hence, for example, use an engineering system on a programming device directly on site and all process data or, as the case may be, diagnostic data of the automation devices 5 will be available to said user simultaneously. The client employed can herein be what is termed a thin client being, for instance, exclusively a browser. The client fetches in each case the required application 3ᵢ for the activity requiring to be performed from the server 2. It is therefore possible for work to be carried out on site for example by a user having an engineering system such as a step 7.

FIG. 2 shows an exemplary embodiment of the system 1 wherein a client 4 accesses process data of automation devices 5a connected via a data transmission system 9 to a further client 4a. The data is transmitted herein over the communication channel 8 and the communication channel 8a. A second communication channel 8a is set up between the terminal server 2 and the second client 4a by the means 6 for feeding in data of the automation devices 5. The data is then transmitted from the client 4a via the terminal server 2 to the client 4. Routing, which is to say forwarding of the corresponding data packets to the client 4 and from the client 4a, is therefore carried out by the online RDP DLL 6 on the server 2. A quasi p2p connection is thus established between the participating clients 4 and 4a.

It is especially advantageous in the example according to the invention that, through the virtual process interfacing, a user is enabled access on an installation via any client 4 to any process data of further automation devices 5a to which the client 4 does not have direct access by means of the online RDP data transmission over the communication channel 8. All the data is hence available for use by a user at any location within the system 1. Highly variable and flexible engineering is made possible for the user by the system 1. Both applications and process data are available at any location within the system 1 via the virtual process interfacing.

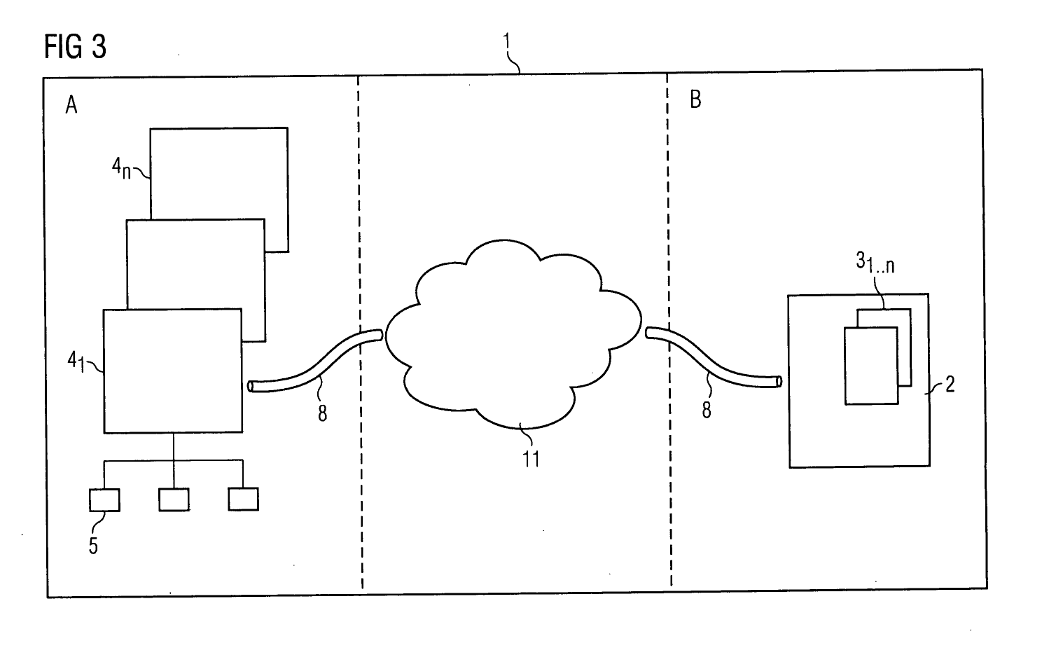

FIG. 3 shows an exemplary embodiment of the system 1 wherein the process data or diagnostic data is transmitted over the internet or, as the case may be, an intranet 11. The clients 4_{1 . . . n} are for this purpose linked to the internet or, as the case may be, an intranet 11 by means of the online RDP protocol via which a communication channel 8 is set up. The terminal server 2 likewise has an internet link via the communication channel 8.

The advantage of the embodiment of the system 1 shown in FIG. 3 is essentially that data, both process data and diagnostic data, can be accessed within the system 1 independently of the specific site across different localities (A, B, C) possibly situated geographically far apart. The use of the proposed system 1 will hence offer a major advantage given today's predominantly heterogeneous structure of automation systems in process and production installations. Engineering actions as well as information-gathering and maintenance operations can be carried out from different locations within the system 1 since all the data is available in realtime at any time and everywhere via the online RDP communication channels 8 and the internet 11. Virtual process interfacing between the participating units within the system 1 is hence ensured at any time. Distributed engineering is thereby rendered possible also in today's predominantly monolithic systems or, as the case may be, applications. It is also advantageous herein that the system 1 is freely scalable. New automation devices 5 can be connected to the system at any time via a simple client 4ᵢ, for example a thin client. The sole prerequisite is an online access. Said access can today even be realized via a W-LAN without any cable laying. Once a W-LAN of this type is present within a specific periphery, the data can also be made available at any time in realtime on mobile clients 4_{1 . . . n}.

To summarize, the invention relates to a system 1 and a method for virtual online process interfacing for distributed engineering systems employed in the field of automation technology based on a Remote Desktop Protocol (RDP). A communication channel 8 is set up for this purpose via an online access from any clients 4 within the system 1 to a server 2 using an RDP. Process data and project-planning data is tunneled over the channel 8. Quasi peer-to-peer communication is enabled between any clients 4 within the system 1 by means of routing on the server 2.

1-20. (canceled)

21. A system for process interfacing within an automation scenario for distributed engineering systems, the system comprising:
a server for providing at least one application required for engineering;
at least one client for accessing automation devices that supply process data and/or project-planning data and for setting up an online communication channel maintained for any length of time between the client and server;
first mechanisms for feeding data of the automation devices into the server via the communication channel; and
second mechanisms for linking the applications to the automation devices, wherein
the first mechanisms have a first interface to a current communication channel and a second interface to the applications, and wherein
the first mechanisms are provided for communicating with the second mechanisms via the communication channel.

22. The system according to claim 21, wherein the client is designed as a programming device and/or as an operator panel and/or as a diagnostic device and/or as a browser and/or as a Windows CE device.

23. The system according to claim 21, wherein the server is designed as a terminal server for use simultaneously by one or more participants.

24. The system according to claim 21, wherein the communication channel is designed as a Remote Desktop Protocol for transmitting data to one or more participants in realtime via one or more separate virtual channels.

25. The system according to claim 21, wherein the first mechanisms are provided for feeding data of further automation devices into the server via the communication channel via at least one further client.

26. The system according to claim 21, wherein the transmission of data in the communication channel is provided via an Intranet and/or an Internet.

27. The system according to claim 21, wherein the transmission of data from the client is provided using a Remote Desktop Protocol via a Wireless LAN.

28. The system according to claim 21, wherein the transmission of data using a Remote Desktop Protocol is provided from further data sources present in the system using standard protocols such as HTTP and/or FTP.

29. The system according to claim 21, wherein the system is provided for use across different sites.

30. A method for process interfacing within an automation scenario for distributed engineering systems, the method comprising:
providing an application required for engineering by a server;
accessing automation devices that supply process data and/or project-planning data via at least one client;
setting up an online communication channel between the client and the server;
feeding the data of the automation devices into the server via the communication channel; and
linking the applications to the automation devices, wherein communication takes place with a second mechanism via the communication channel via a first mechanism having a first interface to a current communication channel and a second interface to the applications.

31. The method according to claim 30, wherein a programming device and/or an operator panel and/or a diagnostic device and/or a browser and/or a Windows CE device is used as the client.

32. The method according to claim 30, wherein one or more participants can use the server simultaneously.

33. The method according to claim 30, wherein a Remote Desktop Protocol for transmitting data to one or more participants in real-time via one or more separate virtual channels is used as the communication channel.

34. The method according to claim 30, wherein data of further automation devices is fed by the first mechanism into the server via the communication channel via at least one further client.

35. The method according to claim 30, wherein data is transmitted in the communication channel over an intranet and/or the Internet.

36. The method according to claim 30, wherein data is transmitted from the client using the Remote Desktop Protocol via a Wireless LAN.

37. The method according to claim 30, wherein data using a Remote Desktop Protocol from further data sources present in the system is transmitted employing standard protocols such as HTTP and/or FTP.

38. The method according to claim 30, wherein the system is used across different sites.

39. A server for providing at least one application required for engineering, the server comprising:
mechanisms for feeding in data of automation devices via a communication channel, wherein said mechanisms having a first interface to a current communication channel and a second interface to the applications.

40. A client for accessing automation devices that supply process data and/or project-planning data and for setting up an online communication channel maintained for any length of time between the client and a server, the client having mechanisms for linking applications provided by the server to the automation devices.
